(19) United States
(12) Patent Application Publication
(10) Pub. No.: US 2016/0009074 A1
(43) Pub. Date: Jan. 14, 2016

(54) INERT CLEAR CYLINDER WITH INERTING ROLLERS

(71) Applicants: STEPHEN J. METCALF, Hudson, WI (US); JARED J. WERTZ, River Falls, WI (US)

(72) Inventors: STEPHEN J. METCALF, Hudson, WI (US); JARED J. WERTZ, River Falls, WI (US)

(21) Appl. No.: 14/798,832

(22) Filed: Jul. 14, 2015

Related U.S. Application Data
(60) Provisional application No. 62/024,103, filed on Jul. 14, 2014.

(51) Int. Cl. B41F 3/54

(52) U.S. Cl. CPC B41F 3/54

(57) ABSTRACT

The substrate being printed is conveyed downstream by rotating inerting and impression cylinders and one or more inerting rollers. The amount of ceiling contact between the inerting cylinder and substrate is determined, at least in part, by vertically adjusting the at least one inerting roller, with respect to the position of the inerting cylinder.

### CROSS-REFERENCES TO RELATED APPLICATIONS

This application claims priority under 35 U.S.C. §119 (e) to, and hereby incorporates by reference, U.S. Provisional Application No. 62/024,103, filed 14 Jul. 2014.

### BACKGROUND OF THE INVENTION

1. Field of the Invention

This invention relates to printing and in particular, this invention relates to curing substrates being printed with radiation-sensitive ink.

2. Background

Modern printing practices utilize rollers to convey substrate at high-speed throughput and to deposit one or more inks during the printing process. After being deposited on the substrate, these one or more inks must be quickly cured to avoid being smeared, warped, or of compromised clarity. One method of curing utilizes radiation-sensitive inks, such as UV-sensitive substances. Many of these radiation-sensitive inks cure incompletely or produce undesirable, side-products when being cured in the presence of atmospheric oxygen. It is, therefore, desirable to affect an apparatus and method to greatly reduce, if not eliminate, the presence of atmospheric oxygen during UV-facilitated curing or polymerization.

### SUMMARY

This invention substantially meets the aforementioned needs of the industry by providing an apparatus and method to greatly reduce, if not eliminate, the presence of atmospheric oxygen during UV-facilitated curing or polymerization.

There is provided an assembly for printing on a substrate, the assembly including a generally transparent, rotatable inerting cylinder; a rotatable impression cylinder; a rotatable inerting roller; and a first source emitting radiation to cure a substance deposited on the substrate, the substrate being conveyed between, and in contact with, the inerting cylinder and the impression cylinder, the inerting roller optionally disposed upstream of the inerting cylinder and the impression cylinder, the inerting roller vertically adjustable so as to adjust the area of the substrate contacting the inerting cylinder. A second irradiation source may be present. The second irradiation source may be positioned upstream of the first irradiation source. A second inerting roller may also be present. If present, the second inerting roller may be positioned downstream of the first inerting roller.

There is provided a method of adjusting the area of a substrate being protected from atmospheric oxygen by an inerting cylinder where ink, deposited on the substrate, is subjected to radiation from a first radiation source, the substrate contacting the inerting cylinder and an impression cylinder, the method comprising adjusting a vertical position of a first inerting roller with respect to the inerting cylinder. A second irradiation source may also be present to irradiate the ink deposited during the printing process. A second inerting roller may also be present, which may be downstream of the inerting cylinder.

There is still yet provided a method of manufacturing an assembly for curing ink on a substrate, the method comprising positioning a transparent impression cylinder and an inerting cylinder such that the contacting substrate is conveyed therebetween; and depositing a first inerting roller such that vertically adjusting the inerting roller with respect to the inerting cylinder adjusts the area of substrate protected from atmospheric oxygen when being irradiated; and placing a first radiation source between the inerting cylinder such that radiation emitted from the first radiation source impinges the portion of substrate being protected from atmospheric oxygen.

These and other objects, features, and advantages of this invention will become apparent from the description which follows, when considered in view of the accompanying drawings.

### BRIEF DESCRIPTION OF THE DRAWINGS

FIG. 1 is a perspective view of one embodiment of an assembly of the inert clear cylinder with inerting rollers of this invention.

FIG. 2 is a side view of the assembly of FIG. 1.

It is understood that the above-described figures are only illustrative of the present invention and are not contemplated to limit the scope thereof.

### DETAILED DESCRIPTION

Unless otherwise defined, all technical and scientific terms used herein have the same meaning as commonly understood by one of ordinary skill in the art to which this invention belongs. Although methods and materials similar or equivalent to those described herein can be used to practice the invention, suitable methods and materials are described below. In addition, the materials, methods, and examples are illustrative only and not intended to be limiting.

Any references to such relative terms as front and back, right and left, top and bottom, upper and lower, horizontal and vertical, raising and lowering, or the like, are intended for convenience of description and are not intended to limit the present invention or its components to any positional or spatial orientation. All dimensions of the components in the attached figures may vary with a potential design and the intended use of an embodiment of the invention without departing from the scope of the invention.

Each of the additional features and methods disclosed herein may be utilized separately or in conjunction with other features and methods to provide improved devices of this invention and methods for making and using the same. Therefore, combinations of features and methods disclosed in the following detailed description may not be necessary to practice the invention in the broadest sense, and are instead taught merely to particularly describe representative and preferred embodiments of the invention.

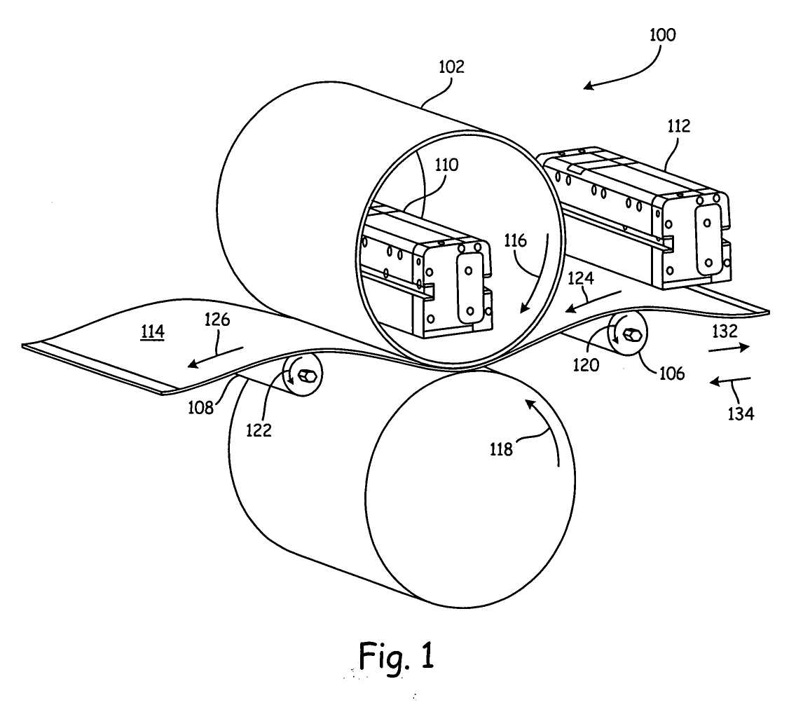

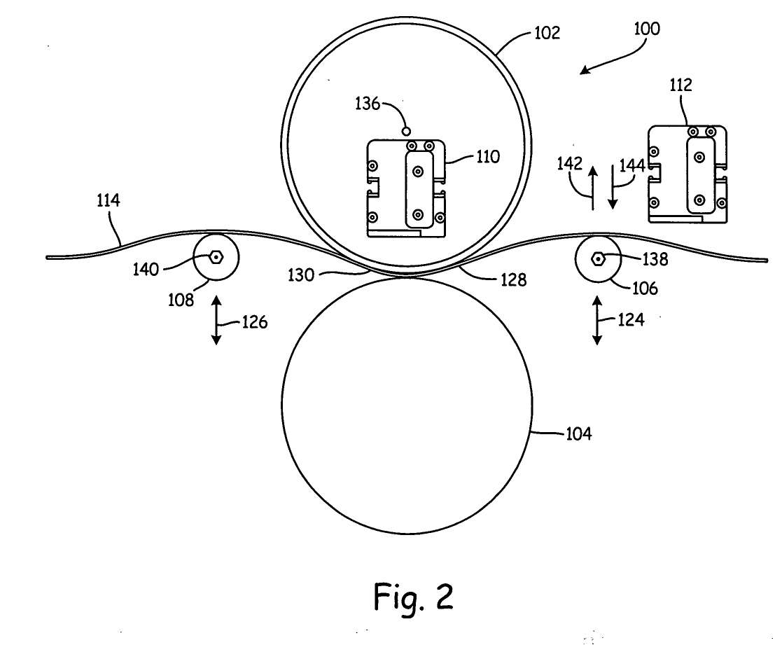

One embodiment of the inerting cylinder assembly of this invention is depicted in FIGS. 1, 2 at 100. The assembly 100 includes an inerting cylinder 102, impression cylinder 104, inerting roller 106, optional inerting roller 108, UV-LED unit 110 and an optional UV-LED unit 112. In the embodiment depicted, a substrate 114 is conveyed between the inerting cylinder 102 and impression cylinder 104, such that the substrate 114 is in contact with the inerting cylinder 102 and impression cylinder 104 and so as to seal the substrate 114 and ink deposited thereon from atmospheric oxygen when radiation, such as UV radiation, emitted from the UV-LED unit 110 impinges the ink deposited on the substrate 114, when the substrate 114 is contacting the inerting and impression cylinders 102, 104, respectively. As well as being conveyed by the inerting and impression cylinders 102, 104 when rotating, as indicated by the respective arrows 116, 118, the substrate 114 is also conveyed by the inerting rollers 106, 108 rotating as indicated by the respective arrows 120, 122. The portion of the substrate 114 in contact with, and sealed by, the inerting cylinder 102 can be readily adjusted by displacing inerting rollers 106, 108 vertically with respect to the location of the inerting cylinder 102 as indicated at 124, 126, respectively. For example, to increase the amount of substrate 114 in contact with, hence being sealed against atmospheric oxygen by, the inerting cylinder 102, the inerting rollers 106, 108 are displaced or adjusted upwardly (raised) with respect to the inerting cylinder 102. Conversely to decrease the amount of substrate 114 in contact with the inerting cylinder 102, the inerting rollers 106, 108 are displaced or adjusted downwardly (lowered). While the optional inerting roller 122 is depicted as being downstream of the inerting roller 120, a single inerting roller may be present in other embodiments of this invention and may be upstream or downstream with respect to the inerting cylinder 102.

One suitable embodiment for generating radiation, such as UV-radiation, is disclosed and described in U.S. Pat. No. 8,558,200, issued 15 Oct. 2013, and assigned to the assignee of this application. While this invention is by no means limited to UV-radiation for curing, UV-radiation may be desirable as less heat is often omitted from UV-admitting fixtures.

Operationally, the substrate 114 is conveyed downstream, as indicated by arrow 134, along the assembly of this invention as indicated by the directional arrows 124, 126 when the respective inerting and offset cylinders 102, 104 and inerting rollers 106, 108 are rotating as explained above. Upstream, the substrate 114 has been printed with one or more radiation-sensitive, such as UV-sensitive, inks. If present, the optional UV-unit 112 directs radiation onto the surface of the substrate 114 to effect an initial curing event. As the substrate 114 is conveyed downstream further, a desired portion of the substrate 114, such as that indicated between 128, 130 is sealed so as to exclude, or greatly limit, the presence of atmospheric oxygen between the inerting cylinder 102 and the surface of the substrate 114, as radiation, for example, UV-radiation, is directed onto the surface of the substrate 114 from the unit 110.

Additional images can be imprinted on the substrate 114 by the impression cylinder 104 and/or upstream inerting roller 108, the additional images could be deposited during the printing process and/or resemble holograms, when cured.

While the optional radiation source 112 is shown upstream, as indicated by arrow 132, from the radiation source 110, the radiation source 112 may be downstream in other embodiments. Additionally, there may be other sources of radiation positioned to provide additional curing as desired.

Stated otherwise and referencing respective rotational axes 136, 138, 140 of the inerting cylinder 102 and inerting cylinders 106, 108, one or more of the respective axes 138, 140 of the inerting cylinders 106, 108 are raised when moved in the direction of arrow 142 or displaced vertically so as to close the distance between the axes 138, 140 to the axis 136. Conversely, the inerting cylinders are lowered when moved in the direction 144 or displaced vertically so as to increase the distance between the axes 138, 140 to the axis 136. Consequently, raising the axes 138, 140 with respect to the axis 136 as described above increases the distance between points 128, 130 to indicate a greater portion of sealed or protected substrate 114. Thus, lowering the axes 138, 140 with respect to the axis 136 as described above decreases the distance between points 128, 130 to indicate a lesser portion of sealed or protected substrate 114

In addition to raising or lowering the inerting rollers 106, 108, the inerting cylinder and impression cylinder 104 could be, optionally simultaneously, raised or lowered with respect to the inerting rollers 106, 108 to effect adjustment of the foregoing sealed or protected portion of the substrate 114 as described above.

Suitable synthetic materials for the inerting cylinder 102 include a synthetic resin transmitting radiation of desired wavelengths, such as polycarbonate, glass, or acrylics. However, a person of ordinary skill in the art will readily recognize that other synthetic resins may be suitable for a given embodiment of this invention. Other suitable synthetic resins may be found in the Handbook of Plastics, Elastomers, and Composites, Charles A. Harper, Editor in Chief, Third Edition, McGraw-Hill, New York, 1996, hereby incorporated by reference.

Because numerous modifications of this invention may be made without departing from the spirit thereof, the scope of the invention is not to be limited to the embodiments illustrated and described. Rather, the scope of the invention is to be determined by the appended claims and their equivalents.

What is claimed is:

1. An assembly for printing on a substrate, comprising:
a generally transparent, rotatable inerting cylinder;
a rotatable impression cylinder;
a rotatable first inerting roller; and
a first source emitting radiation to cure a substance deposited on said substrate,
said substrate conveyed between, and in contact with, said inerting cylinder and said impression cylinder, said first inerting roller disposed upstream of said inerting cylinder and said impression cylinder, said inerting roller vertically adjustable so as to adjust the area of substrate contacting said inerting cylinder.

2. The assembly of claim 1, wherein said inerting cylinder comprises glass.

3. The assembly of claim 1, wherein said inerting cylinder comprises a transparent synthetic resin.

4. The assembly of claim 1, wherein said inerting cylinder transmits UV radiation.

5. The assembly of claim 1, further comprising a second source emitting radiation to cure said substance deposited on said substrate.

6. The assembly of claim 5, wherein said second source is positioned upstream of said first source.

7. The assembly of claim 1, wherein said inerting roller is disposed downstream of said inerting cylinder and said impression cylinder.

8. The assembly of claim 1, further comprising a rotatable second inerting roller.

9. The assembly of claim 8, wherein said second inerting roller is disposed downstream of said inerting cylinder and said impression cylinder.

10. The assembly of claim 1, wherein said first source emits UV-radiation.

11. A method of adjusting an area of a substrate protected from atmospheric oxygen by an inerting cylinder, where ink deposited on said substrate is subjected to radiation from a first radiation source, said substrate contacting said inerting cylinder and an impression cylinder, comprising vertically adjusting a first inerting roller with respect to said inerting cylinder.

12. The method of claim 11, wherein a second inerting roller is vertically adjusted with respect to said inerting cylinder.

13. The method of claim 11, wherein said ink is subjected to radiation from a second radiation source.

14. The method of claim 11, wherein said radiation includes UV radiation.

15. A method of manufacturing an assembly for curing ink on a substrate, comprising:
positioning an impression cylinder and a transparent inerting cylinder such that said contacting substrate is conveyed and contacted therebetween; and
disposing a transparent first inerting roller such that vertically adjusting said first inerting roller with respect to said inerting cylinder adjusts the area of substrate protected from atmospheric oxygen when being irradiated; and
placing a first radiation source between within said inerting cylinder such that radiation emitted from said first radiation source impinges the portion of substrate being protected from atmospheric oxygen.

16. The method of claim 15, further comprising disposing a second inerting roller such that vertically adjusting said second inerting roller with respect to said inerting cylinder adjusts the area of substrate protected from atmospheric oxygen when being irradiated.

17. The method of claim 16, wherein said second inerting roller is downstream of said first inerting roller.

18. The method of claim 15, further comprising placing a second radiation source so as to further irradiate said substrate.

19. The method of claim 18, wherein said second radiation source is upstream of said first radiation source.

20. The method of claim 15, wherein said radiation includes UV radiation.
